(19) United States
(12) Patent Application Publication
(10) Pub. No.: US 2005/0111378 A1
(43) Pub. Date: May 26, 2005

(54) Registered state change notification for a fibre channel network

(76) Inventors: Xiaoheng "Cora" Chen, Fremont, CA (US); Sundar Poudyal, Pleasanton, CA (US); Daotang Yang, Sunnyvale, CA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/938,404

(22) Filed: Sep. 10, 2004

Related U.S. Application Data
(60) Provisional application No. 60/502,367, filed on Sep. 12, 2003.

(51) Int. Cl. H04L 1/00

(52) U.S. Cl. 370/252; 370/400

(57) ABSTRACT

Disclosed herein are various aspects of a Fibre Channel (Fibre Channel) fabric having switches that employ Registered State Change Notifications (RSCNs) with enhanced payloads. Two types of RSCN message formats are provided, both including status information about the affected device(s). In one embodiment, a RSCN message format for inter-switch communication provides various information about the affected devices according to one of a plurality of predetermined formats. In another embodiment, a node device RSCN message format provides information about a port state, the identification of the affected port, along with the port and node world wide names and the FC-4 types supported by the node.

### CROSS-REFERENCE TO RELATED APPLICATIONS

This application is related to and claims priority from U.S. Provisional Patent Application Ser. No. 60/502,367, filed Sep. 12, 2003, entitled “New RSCN Format,” which is hereby incorporated by reference. This application is also related to U.S. patent application Ser. No. 10/208,375, filed Jul. 30, 2002, entitled “Fibre Channel Network Employing Registered State Change Notifications with Enhanced Payload,” which is hereby incorporated by reference.

### BACKGROUND OF THE INVENTION

1. Field of the Invention

This invention generally relates to systems and methods for providing network communications between computers or computer system components. More specifically, this invention relates to increasing the scalability of Fibre Channel networks through the use an extended registered state change notification (RSCN) packet payload.

2. Background of the Invention

Networking of high-performance computers has become the focus of much attention in the data communications industry. Performance improvements in processors and peripherals, along with the move to distributed architectures such as client/server configurations, have spawned increasingly data-intensive and high-speed network applications, such as medical imaging, multimedia, and scientific visualization.

One protocol that has been developed to provide the necessary communications capacity is the Fibre Channel protocol. The Fibre Channel protocol defines standard media and signaling conventions for transporting data in a serial fashion. It also provides an error correcting channel code and a frame structure for transporting the data. Further, the Fibre Channel protocol sets out a buffer-credit-based flow control methodology, and creates some common services (e.g., fabric controller, name server). The Fibre Channel protocol can be applied to various network topologies including point-to-point, ring, and switched fabric. Further details regarding the Fibre Channel protocol can be found online at www.fibrechannel.org.

Fibre Channel networks can grow quite large. The protocol theoretically allows for nearly 2²⁴ (over 16 million) node ports within a single fabric (a Fibre Channel network includes one or more Fibre Channel fabrics). Each node port supports one Fibre Channel device. As larger networks are implemented (e.g., more than about eight switches), various unforeseen weaknesses in the Fibre Channel protocol become evident. For example, the amount of network traffic necessary to support and use the name server grows as the square of the number of devices attached to the fabric, and this traffic can at times severely impair the performance of the network. It would be desirable to eliminate or mitigate the adverse effects of this traffic, thereby improving the speed, efficiency, and reliability of larger networks.

### SUMMARY OF THE INVENTION

The problems outlined above are in large measure addressed by a Fibre Channel (Fibre Channel) fabric having switches that employ Registered State Change Notifications (RSCNs) with enhanced payloads. Two types of RSCN message formats are provided, both including status information about the affected device(s). In one embodiment, a RSCN message format for inter-switch communication provides various information about the affected devices according to one of a plurality of predetermined formats. In another embodiment, a node device RSCN message format provides information about a port state, the identification of the affected port, along with the port and node world wide names and the FC-4 types supported by the node.

### BRIEF DESCRIPTION OF THE DRAWINGS

FIG. 1 illustrates an example Fibre Channel network.

FIG. 2 illustrates a prior art inter-switch RSCN message format.

FIG. 3 illustrates an inter-switch RSCN message format according to the present invention.

FIG. 4 is a table illustrating the message content of five formats of the inter-switch RSCN message format of FIG. 3.

FIG. 5 illustrates a prior art node device RSCN message format.

FIG. 5A illustrates the bit values of the RSCN Event Qualifier field of the RSCN message illustrated in FIG. 5.

FIG. 6 illustrates a node device RSCN message format according to the present invention.

FIG. 7A illustrates a prior art State Change Registration payload.

FIG. 7B illustrates the Registration Function values for the State Change Registration payload of FIG. 7A.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

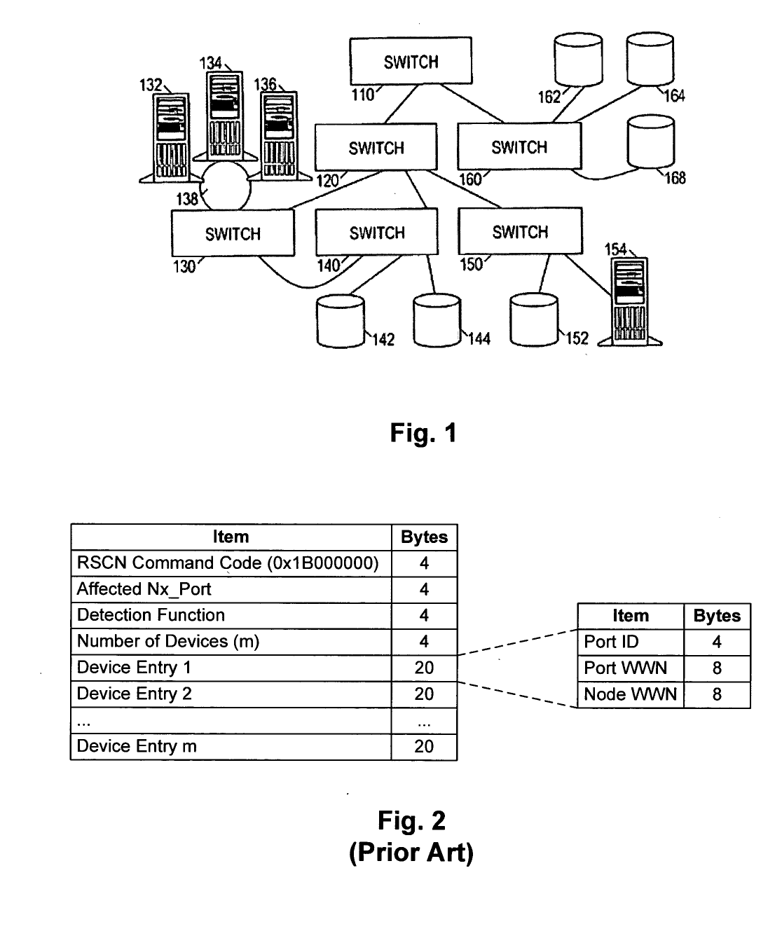

Turning now to the figures, FIG. 1 shows an illustrative Fibre Channel fabric having six interconnected switches 110, 120, 130, 140, 150 and 160. Switches 110 and 120 are not directly coupled to any Fibre Channel node devices, while switches 130, 140, 150 and 160 are directly coupled to Fibre Channel node devices. Switch 130 is coupled to three Fibre Channel node devices 132-136 by an arbitrated loop 138. Switch 140 is directly coupled to two Fibre Channel node devices 142 and 144. Switch 150 is directly coupled to Fibre Channel node devices 152-154, and switch 160 is directly coupled to Fibre Channel node devices 162-168.

Although not shown in FIG. 1, a Fibre Channel fabric may also include phantom devices. A phantom device is a logical node device that may be created by a switch. One situation where a phantom device may be desirable is an arbitrated loop. Loop node devices 132-136 may be private devices, meaning that they are not configured to engage in communications outside the loop 138. The switch 130 allows external node devices (e.g., node device 154) to communicate with private node devices in the loop by creating a phantom node device on arbitrated loop 138 and making communications to and from the external node device appear like communications to and from the phantom device.

In addition to providing basic connectivity between Fibre Channel node devices, the switches preferably provide additional Fibre Channel fabric services such as fabric controller, directory server (also known as a “name server”), time server, management server, quality of service facilitator, and alias server. These services may be localized to an individual switch, or they may be distributed among the switches.

Each of the node devices typically determines the properties of the other node devices with which it communicates. After connecting to the network, which is done with a fabric login (FLOGI) command, the node devices send a request addressed to the name server, which is then received by the resident name server on the entry switch. Typically, where such request forms are supported, the request takes the form of GE_PT (get entries of a given Port Type) or GE_FT (get entries of a given FC-4 Type). Where such forms are not supported, the request may take the form of GID_PT (get identifiers for ports of a given Port Type) or GID_FT (get identifiers for ports of a given FC-4 Type). Once the identifiers have been obtained, a series of GE_ID (get entry for a given identifier) requests may be used to obtain the corresponding entries. In either case, the effect is to cause the entry switch to request each of the other switches to send all name server database entries that satisfy the given criteria to the entry switch, which then forwards the entries to the requesting device. The requesting device then uses the returned information to log in to the port with which it needs to connect (using the PLOGI command) and initiates communication (using the PRLI command).

The requests to the name server can generate increasing amounts of traffic as the size of the network increases. The number of entries is generally proportional to the number of node devices, and each device will typically generate such a sequence of requests when it connects to the network, so the amount of traffic increases as the square of the number of node devices. The situation is exacerbated when one considers that node devices are not static. Their status or properties may change, e.g., when disconnected or reprogrammed. The frequency of change is generally proportional to the number of node devices. Each time a node device experiences an event that affects their name server entry, a Registered State Change Notification (RSCN) message is sent to all the node devices in the same zone (or, at least, those node devices in the same zone that have registered to receive such messages). Each of those node devices typically responds immediately with a GE_ID request, forcing the entry switch of the affected device to contend with a sudden influx of name server traffic.

Note that RSCN messages are classified into two types: inter-switch RSCN messages, and node device RSCN messages. RSCN messages exchanged between switches are given an inter-switch format, but this format is different from the node device format used by (and expected by) node devices. Both formats are discussed herein. New formats for each type of RSCN message are described in greater detail below. Not all switches or devices may support the new format, but it is generally possible for one device to determine the capabilities of the other devices with which it communicates. For example, the one switch may query other switches to determine their manufacturer and firmware version. Switches having a particular manufacturer and revision number may be presumed to support the new format. If for some reason it is not possible to determine the capability of another device, the devices communicating therewith can default to previous RSCN formats when communicating with that switch.

Referring to FIG. 2, the payload for a standard, prior art inter-switch RSCN message is illustrated. The first four bytes of the RSCN message payload are the inter-switch RSCN command code, which is a hexadecimal value of 0×1B000000. The next four bytes identify the affected Nx_Port (i.e., N_Port or NL_Port). The first nibble (four bits) of the high order byte in the affected N_Port field can take on one of three values. If this nibble has a value of 0×0, this is an indication that no information about the port status is available. If this nibble has a value of 0×1, this is an indication that the port is online. If this nibble has a value of 0×2, this is an indication that the port is offline.

The second nibble of the high order byte is used to indicate the address format used to identify the affected port. A value of 0×0 indicates that the address is in the port address format. A value of 0×1 indicates that the address is in area address format. A value of 0×2 indicates that the address is in domain address format. Finally, a value of 0×3 indicates that the address is in fabric address format. The remaining three bytes of the Affected N_Port field contain the 24-bit address in the format specified.

The next four bytes of the standard RSCN payload identify the “detection function,” which is the element that detected the change triggering the RSCN. A value of 0×00000001 indicates that the change was detected by the fabric, while a value of 0×00000002 indicates that the change was detected by an N_Port. The next four bytes of the RSCN payload indicate the number of device entries in the payload. For each of these device entries, there is a 20-bit device entry, which constitutes the remaining payload.

The 20-bit device entry data defined in the standard RSCN message format is somewhat limited. As indicated in FIG. 2, the data includes only port ID, port world wide name (WWN), and node WN. If a remote switch receiving the RSCN message wants to know more device information about one or more of the devices identified in the RSCN message, it must query the local switch and wait for response to get the data. According to the present invention, this increased traffic on the network and increased workload on the switches can be avoided if the inter-switch RSCN device entry is modified to include additional device information. Then, by pushing the RSCN message to other switches, those switches can build cached device databases with more detailed device attributes. Additional details of such a caching system are disclosed in U.S. patent application Ser. No. 10/208,376, filed Jul. 30, 2002, entitled “Fibre Channel Switch Having a Push/Pull Method for Caching Remote Switch Information,” which is hereby incorporated by reference.

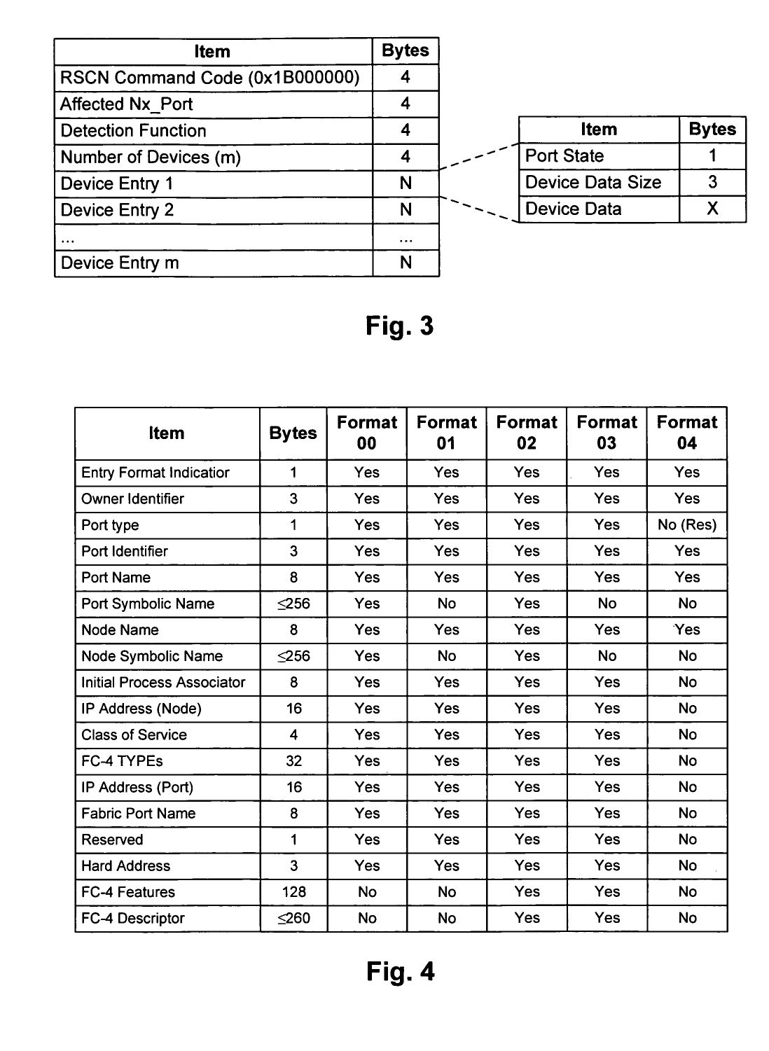

An inter-switch RSCN message payload according to the present invention to alleviate the problem of increased network traffic and increased switch workload is illustrated in FIG. 3. The first 16 bytes of the proposed RSCN payload are identical to the first 16 bytes of the existing standard RSCN payload. However, the device entry field is changed to a variable length field. Flexibility and information content in the RSCN message is enhanced by having multiple RSCN payload formats for the variable length device entry fields. Different information is provided in the RSCN message depending on the specified format. Information content of five preferred formats is illustrated in FIG. 4.

Format 00 is the large name server entry object. In this format, the device data field is a maximum of 624 bytes in length and includes the fields indicated with a “yes” in the third column of the chart in FIG. 4. Format 01 is the small name server entry object, which corresponds to the large name server entry object, but lacks the port symbolic name and node symbolic name fields. In this format, the device data field is 112 bytes in length (624 bytes minus the 256 byte maximum port symbolic name and the 256 byte maximum node symbolic name fields). Format 02 includes the large name server entry object and also includes two additional fields, an FC-4 feature listing (128 bytes) and an FC-4 Descriptor (260 bytes maximum). Using Format 02, the device data field has a maximum length of 1012 bytes. Format 03 includes the small name server entry object and also includes FC-4 features and an FC-4 descriptor. Like Format 01, it excludes the 256 byte (maximum) port symbolic name and the 256 byte (maximum) node symbolic name, resulting in a data field length of 500 bytes. Finally, Format 04 includes the fields identified in the rightmost column of the chart in FIG. 4, resulting in a device data field having a length of 23 bytes, although 1 byte is reserved for the port type field. Because the some of the fields, e.g., port and node symbolic name, may vary in size, the device data size field (illustrated in FIG. 3) specifies the size of the entire entry (port state plus device data size plus device data).

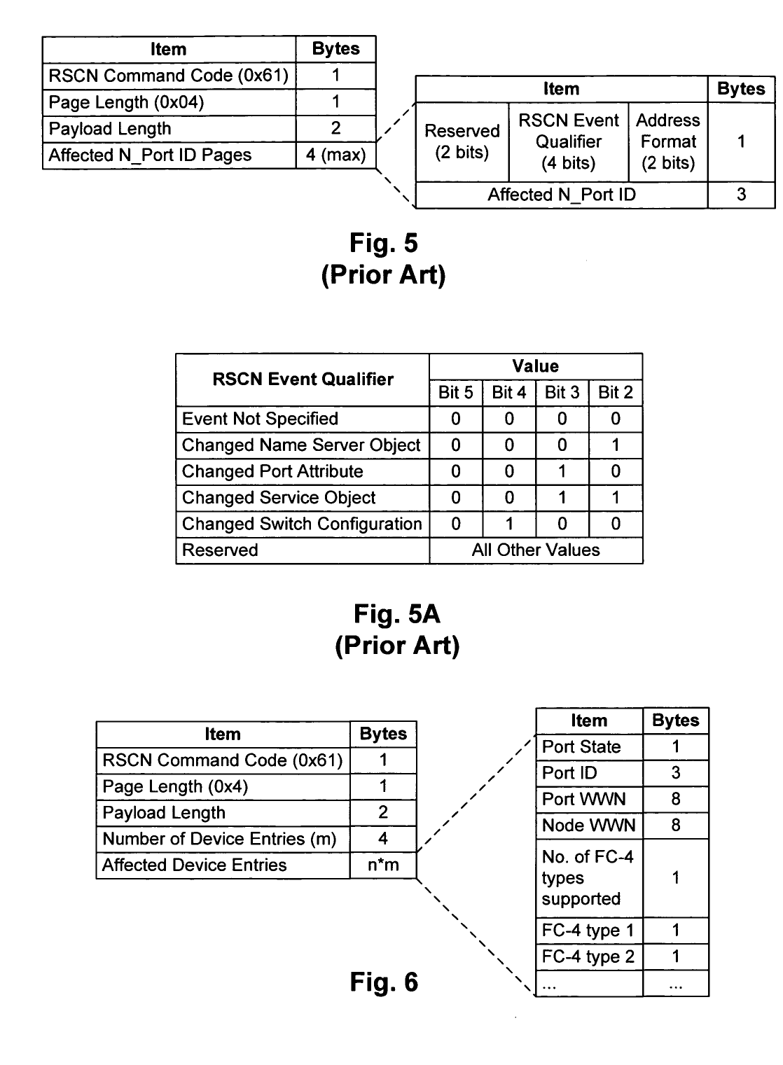

With reference to FIG. 5, the standard, prior art end-device RSCN payload is illustrated. The end-device RSCN payload comprises the RSCN command code (0×61), a page length (0×04), a payload length of 2 bytes, and the affected N_Port ID Pages. Each affected N_Port ID page is four bytes. The first byte is divided into three fields. The two high order bits are reserved. The next four bits are an RSCN Event Qualifier. These four bits take on the values indicated by FIG. 5A for each of the identified RSCN triggering events. The remaining two bits of the first byte are the address format. The remaining three bytes are the address of the affected port in the format specified by the first byte.

In the current payload, there is no indication of the device being online or offline, which requires the HBA to query back to the name server to ascertain the status of the affected device. Also, many HBAs are interested in the commonly used device data, such as port WWN, node WWN, and FC-4 types. Again, an HBA has to query the name server in response to the RSCN to determine this information. Typically, when an HBA receives a RSCN, it makes a name server query GID_FT first to get the fabric device port IDs given a specified FC-4 type. Then, for each device port ID, the HBA makes a name server query GPN_ID or GNN_ID to get the device WWN individually. Afterwards, the HBA sends a PLOGI to the targets to start IO traffic. According to the present invention, all of the above name server queries can be avoided if the required information is put in the RSCN payload, and if the host can interpret the RSCN intelligently.

This is accomplished by the preferred RSCN payload format illustrated in FIG. 6. The RSCN command code (0×61) and the page length (0×4) are unchanged from the prior art payload format. The next two bytes indicate a payload length. This is followed by four bytes indicating the number of device entries in the RSCN message. Finally, the affected device entries are listed, with each entry including the following information: port state (1 byte), port ID (3 bytes), port WWN (8 bytes), node WWN (8 bytes), number of FC-4 types supported (1 byte), and a 1 byte listing of each of the supported FC-4 types.

The port state byte indicates the device's online or offline status. The state byte may be the same as for an inter-switch RSCN, and thus ‘0×’ indicates that no additional information on the state is available, ‘1×’ indicates that the port is online, ‘2×’ indicates that the port is offline. A device could support multiple FC-4 types, so all of the supported FC-4 types are listed in the payload. Each FC-4 type is an 8-bit encoded FC-PH value.

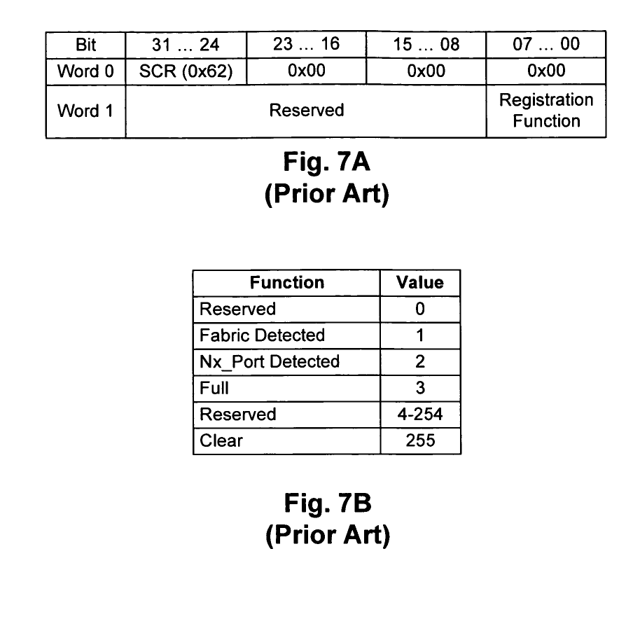

Because this RSCN format relies on the acceptance on the host side, the host can notify the switch about which type of RSCN it can support through a State Change Registration (SCR) frame. A prior art SCR payload is illustrated in FIG. 7A. The payload comprises two words of four bytes each. The first byte of the first word is the SCR command, which has a value of 0×62 to identify the frame as an SCR. The last byte of the second word is a Registration Function, which specifies what types of RSCN messages a device is registering to receive. Currently, values of 0, 1, 2, and 3 are used, as illustrated in FIG. 7B. A value of 1 indicates a registration to receive RSCN requests issued by the Fabric Controller for events detected by the fabric. A value of 2 indicates a registration to receive RSCN requests issued for events detected by the affected Nx_Port. A value of 3 serves to register the device to receive all RSCN requests. An additional bit in this frame is preferably used to indicate what type of RSCN messages are supported by a device. For example, a 0 can be used to indicate the prior art RSCN format and 1 can be used to indicate that the new scalable RSCN format described herein is supported. This value may be placed in one of the first three bytes of the second word, currently indicated as reserved. Alternatively, one of the values 4-254 for the registration function may be used.

The preferred RSCN messages may take the physical form of modulated carrier signals traveling over fabric links. The carrier signals may be modulated into a sequential series of signal frames, each having a start of frame segment, a frame header, a content segment, and an end of frame segment. The field formats shown in the figures would describe the arrangement of information in the content segment following the frame header. The appropriate signaling protocols can be found in the Fibre Channel Framing and Signaling Draft Standard Rev. 1.70, FC-FS, published Feb. 8, 2002, and the Fibre Channel Physical and Signaling Interface, Rev. 4.3, FC-PH, published Jun. 4, 1994, both of which are incorporated herein by reference.

By providing additional information in the RSCN message, as described herein, it is possible to significantly reduce the amount of network traffic caused by state changes in one or more devices. By eliminating the need for each device receiving an RSCN message to query the name server to determine required details about the state change, the number of devices that may be connected to a fabric is effectively increased. Numerous variations and modifications of the techniques described herein will become apparent to those skilled in the art once the above disclosure is fully appreciated. It is intended that the following claims be interpreted to embrace all such variations and modifications.

1. A network comprising:
a plurality of interconnected switches; and
a plurality of node devices, each node device connected to at least one of the plurality of switches;
wherein at least one of the plurality of switches is configured to transmit Registered State Change Notification messages to the other switches after a node device state change is detected; and
wherein the Registered State Change Notification messages comprise a device entry field, the device entry field containing information indicating a status of a changed node device and wherein the device entry field further comprises additional information beyond Port Identifier, Port World Wide Name, and Node World Wide Name.

2. The network of claim 1 wherein the device entry field comprises a port state field and a device data field.

3. The network of claim 2 wherein the device entry field further comprises an indication of a size of the device data field.

4. The network of claim 2 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

5. The network of claim 2 wherein the device data field comprises a plurality of parameters about the changed node device.

6. The network of claim 5 wherein the plurality of parameters is determined by selecting one of a plurality of predetermined formats for the device data field, each of the plurality of predetermined formats comprising one or more fields indicative of a status of the changed node device.

7. The network of claim 1 wherein the at least one of the plurality of switches is further configured to transmit Node Device Registered State Change Notification messages to at least one of the plurality of node devices after a node device state change is detected; and wherein the Registered State Change Notification messages comprise information beyond Address Format and Affected Port Identifier.

8. The network of claim 7 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

9. The network of claim 7 wherein the device data field comprises a plurality of parameters about the changed node device.

10. A method of providing information about node devices on a network, the method comprising:
receiving node device change messages from local node devices; and
transmitting Inter-switch Registered State Change Notification messages to other devices in response to the received node device change messages, wherein the Registered State Change Notification messages comprise a device entry field, the device entry field containing information indicating a status of a changed node device and wherein the device entry field further comprises additional information beyond Port Identifier, Port World Wide Name, and Node World Wide Name.

11. The method of claim 10 wherein the device entry field comprises a port state field and a device data field.

12. The method of claim 11 wherein the device entry field further comprises an indication of a size of the device data field.

13. The method of claim 11 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

14. The method of claim 11 wherein the device data field comprises a plurality of parameters about the changed node device.

15. The method of claim 14 wherein the plurality of parameters is determined by selecting one of a plurality of predetermined formats for the device data field, each of the plurality of predetermined formats comprising one or more fields indicative of a status of the changed node device.

16. The method of claim 10 further comprising:
transmitting Node Device Registered State Change Notification messages to other devices in response to receiving the node device change messages, wherein the Node Device Registered State Change Notification messages comprise information beyond Address Format and Affected Port Identifier.

17. The method of claim 16 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

18. The method of claim 16 wherein the device data field comprises a plurality of parameters about the changed node device.

19. A Fibre Channel fabric comprising:
a first Fibre Channel switch connected to at least one Fibre Channel node device; and
a second Fibre Channel switch coupled to the first Fibre Channel switch;
wherein the first Fibre Channel switch is configured to transmit Inter-switch Registered State Change Notification messages to the second Fibre Channel switch upon detecting a state change in the at least one Fibre Channel node device connected to the first Fibre Channel switch; and
wherein the Registered State Change Notification messages comprise a device entry field, the device entry field containing information indicating a status of the changed node device and wherein the device entry field further comprises additional information beyond Port Identifier, Port World Wide Name, and Node World Wide Name.

20. The Fibre Channel fabric of claim 19 wherein the device entry field comprises a port state field and a device data field.

21. The Fibre Channel fabric of claim 20 wherein the device entry field further comprises an indication of a size of the device data field.

22. The Fibre Channel fabric of claim 20 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

23. The Fibre Channel fabric of claim 20 wherein the device data field comprises a plurality of parameters about the changed node device.

24. The Fibre Channel fabric of claim 23 wherein the plurality of parameters is determined by selecting one of a plurality of predetermined formats for the device data field, each of the plurality of predetermined formats comprising one or more fields indicative of a status of the changed node device.

25. The Fibre Channel fabric of claim 19 wherein the Fibre Channel switch is further configured to transmit Node Registered State Change Notification messages to at least one other node device connected to the first Fibre Channel switch upon detecting a state change in the at least one node device; and wherein the Node Registered State Change Notification messages comprise additional information beyond Address Format and Affected Port Identifier.

26. The Fibre Channel fabric of claim 25 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

27. The Fibre Channel fabric of claim 25 wherein the device data field comprises a plurality of parameters about the changed node device.

28. A Fibre Channel frame signal embodied in a carrier wave comprising:
a start of frame segment encoding a start-of-frame indicator;
a content segment encoding:
an Inter-switch Registered State Change Notification command code; and
a device entry field comprising additional information indicating a status of a changed node and further comprising additional information beyond Port Identifier, Port World Wide Name, and Node World Wide Name; and
an end of frame segment encoding an end-of-frame indicator.

29. The Fibre Channel frame signal of claim 28 wherein the device entry field further comprises a port state field and a device data field.

30. The Fibre Channel frame of claim 29 wherein the device entry field further comprises an indication of a size of the device data field.

31. The Fibre Channel frame of claim 29 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

32. The Fibre Channel frame of claim 29 wherein the device data field comprises a plurality of parameters about the changed node device.

33. The Fibre Channel frame of claim 32 wherein the plurality of parameters is determined by selecting one of a plurality of predetermined formats for the device data field, each of the plurality of predetermined formats comprising one or more fields indicative of a status of the changed node device.

34. A network comprising:
a plurality of interconnected switches; and
a plurality of node devices, each node device connected to at least one of the plurality of switches;
wherein at least one of the plurality of switches is configured to transmit Registered State Change Notification messages to at least one of the plurality of node devices after a node device state change is detected; and
wherein the Registered State Change Notification messages comprise information beyond Address Format and Affected Port Identifier.

35. The network of claim 34 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

36. The network of claim 34 wherein the device data field comprises a plurality of parameters about the changed node device.

37. A method of providing information about node devices on a network, the method comprising:
receiving node device change messages from local node devices; and
transmitting Registered State Change Notification messages to other devices in response to receiving the node device change messages, wherein the Registered State Change Notification messages comprise information beyond Address Format and Affected Port Identifier.

38. The method of claim 37 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

39. The method of claim 37 wherein the device data field comprises a plurality of parameters about the changed node device.

40. A Fibre Channel fabric comprising:
a Fibre Channel switch connected to a plurality of Fibre Channel node devices;
wherein the Fibre Channel switch is configured to transmit Registered State Change Notification messages to at least one of the node devices upon detecting a state change in at least one other node device; and
wherein the Registered State Change Notification messages comprise additional information beyond Address Format and Affected Port Identifier.

41. The Fibre Channel fabric of claim 40 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

42. The Fibre Channel fabric of claim 40 wherein the device data field comprises a plurality of parameters about the changed node device.

43. A Fibre Channel frame signal embodied in a carrier wave comprising:
a start of frame segment encoding a start of frame indicator;
a content segment encoding:
a Node Registered State Change Notification command code; and
additional information beyond Address Format and Affected Port Identifier; and
an end of frame segment encoding an end of frame indicator.

44. The Fibre Channel frame signal of claim 43 wherein the content segment comprises an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

45. The Fibre Channel frame signal of claim 43 wherein the device data field comprises a plurality of parameters about the changed node device.

46. A Fibre Channel switch comprising:
at least one connection configured to communicate with a node device; and
at least one connection configured to communicate with a second Fibre Channel switch;
wherein the Fibre Channel switch is configured to detect a change in status of the node device and transmit an Inter-switch Registered State Change Notification message to the second switch after the node device status change is detected; and
wherein the Inter-switch Registered State Change Notification message comprises a device entry field, the device entry field containing information indicating the status of the node device and wherein the device entry field further comprises additional information about the node device beyond Port Identifier, Port World Wide Name, and Node World Wide Name.

47. The Fibre Channel switch of claim 46 wherein the device entry field comprises a port state field and a device data field.

48. The Fibre Channel switch of claim 47 wherein the device entry field further comprises an indication of a size of the device data field.

49. The Fibre Channel switch of claim 47 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, hard Address, FC-4 Features, and FC-4 Descriptor.

50. The Fibre Channel switch of claim 47 wherein the device data field comprises a plurality of parameters about the node device.

51. The Fibre Channel switch of claim 50 wherein the plurality of parameters is determined by selecting one of a plurality of predetermined formats for the device data field, each of the plurality of predetermined formats comprising one or more fields indicative of a status of the node device.

52. The Fibre Channel switch of claim 46 wherein the Fibre Channel switch is further configured to detect a change in status of the node device and transmit a Node Device Registered State Change Notification message to a second node device connected to the Fibre Channel switch after the node device status change is detected and wherein the Node Device Registered State Change Notification message comprises additional information beyond Address Format and Affected Port Identifier.

53. The Fibre Channel switch of claim 52 wherein the Node Device Registered State Change Notification message comprises an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

54. The Fibre Channel switch of claim 52 wherein the device data field comprises a plurality of parameters about the changed node device.

55. A Fibre Channel switch comprising:
a plurality of connections each configured to communicate with a node device;
wherein the Fibre Channel switch is configured to detect a change in status of a first node device and transmit a Node Device Registered State Change Notification message a second node device after the node device status change is detected; and
wherein the Node Device Registered State Change Notification message comprises additional information beyond Address Format and Affected Port Identifier.

56. The Fibre Channel switch of claim 55 wherein the Node Device Registered State Change Notification message comprises an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

57. The Fibre Channel switch of claim 55 wherein the device data field comprises a plurality of parameters about the changed node device.

58. A network comprising:
a plurality of interconnected switches; and
a plurality of node devices, each node device connected to at least one of the plurality of switches;
wherein at least one of the plurality of switches is configured to receive and interpret Registered State Change Notification messages from another switch after a node device state change is detected; and
wherein the Registered State Change Notification messages comprise a device entry field, the device entry field containing information indicating a status of a changed node device and wherein the device entry field further comprises additional information beyond Port Identifier, Port World Wide Name, and Node World Wide Name.

59. The network of claim 58 wherein the device entry field comprises a port state field and a device data field.

60. The network of claim 59 wherein the device entry field further comprises an indication of a size of the device data field.

61. The network of claim 59 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

62. The network of claim 59 wherein the device data field comprises a plurality of parameters about the changed node device.

63. The network of claim 62 wherein the plurality of parameters is determined by selecting one of a plurality of predetermined formats for the device data field, each of the plurality of predetermined formats comprising one or more fields indicative of a status of the changed node device.

64. A method of receiving information about node devices on a network, the method comprising:
receiving and interpreting Inter-switch Registered State Change Notification messages from a device on the network, wherein the Registered State Change Notification messages comprise a device entry field, the device entry field containing information indicating a status of a changed node device and wherein the device entry field further comprises additional information beyond Port Identifier, Port World Wide Name, and Node World Wide Name.

65. The method of claim 64 wherein the device entry field comprises a port state field and a device data field.

66. The method of claim 65 wherein the device entry field further comprises an indication of a size of the device data field.

67. The method of claim 65 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

68. The method of claim 65 wherein the device data field comprises a plurality of parameters about the changed node device.

69. The method of claim 68 wherein the plurality of parameters is determined by selecting one of a plurality of predetermined formats for the device data field, each of the plurality of predetermined formats comprising one or more fields indicative of a status of the changed node device.

70. A Fibre Channel fabric comprising:
a first Fibre Channel switch connected to at least one Fibre Channel node device; and
a second Fibre Channel switch coupled to the first Fibre Channel switch;
wherein the second Fibre Channel switch is configured to receive and interpret Inter-switch Registered State Change Notification messages from the first Fibre Channel switch transmitted in response to a state change in the at least one Fibre Channel node device connected to the first Fibre Channel switch; and
wherein the Registered State Change Notification messages comprise a device entry field, the device entry field containing information indicating a status of the changed node device and wherein the device entry field further comprises additional information beyond Port Identifier, Port World Wide Name, and Node World Wide Name.

71. The Fibre Channel fabric of claim 70 wherein the device entry field comprises a port state field and a device data field.

72. The Fibre Channel fabric of claim 71 wherein the device entry field further comprises an indication of a size of the device data field.

73. The Fibre Channel fabric of claim 71 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, Hard Address, FC-4 Features, and FC-4 Descriptor.

74. The Fibre Channel fabric of claim 71 wherein the device data field comprises a plurality of parameters about the changed node device.

75. The Fibre Channel fabric of claim 74 wherein the plurality of parameters is determined by selecting one of a plurality of predetermined formats for the device data field, each of the plurality of predetermined formats comprising one or more fields indicative of a status of the changed node device.

76. A network comprising:
at least one switch; and
a plurality of node devices, each node device connected to the at least one switch;
wherein at least one of the plurality of node devices is configured to receive and interpret Registered State Change Notification messages from the at least one switch after a node device state change is detected by the at least one switch; and
wherein the Registered State Change Notification messages comprise information beyond Address Format and Affected Port Identifier.

77. The network of claim 76 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

78. The network of claim 76 wherein the device data field comprises a plurality of parameters about the changed node device.

79. A method of receiving information about node devices on a network, the method comprising:
receiving and interpreting Registered State Change Notification messages to other devices in response to receiving the node device change messages, wherein the Registered State Change Notification messages comprise information beyond Address Format and Affected Port Identifier.

80. The method of claim 79 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

81. The method of claim 79 wherein the device data field comprises a plurality of parameters about the changed node device.

82. A Fibre Channel fabric comprising:
a Fibre Channel switch connected to a plurality of Fibre Channel node devices;
wherein at least one of the plurality of Fibre Channel node devices is configured to receive and interpret Registered State Change Notification messages from the Fibre Channel switch sent upon the Fibre Channel switch detecting a state change in at least one other node device; and
wherein the Registered State Change Notification messages comprise additional information beyond Address Format and Affected Port Identifier.

83. The Fibre Channel fabric of claim 82 wherein the Registered State Change Notification messages comprise an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

84. The Fibre Channel fabric of claim 82 wherein the device data field comprises a plurality of parameters about the changed node device.

85. A Fibre Channel switch comprising:
at least one connection configured to communicate with a node device; and
at least one connection configured to communicate with a second Fibre Channel switch;
wherein the Fibre Channel switch is configured to receive and interpret an Inter-switch Registered State Change Notification message from the second switch after the node device status change is detected by the second Fibre Channel switch; and
wherein the Inter-switch Registered State Change Notification message comprises a device entry field, the device entry field containing information indicating the status of the node device and wherein the device entry field further comprises additional information about the node device beyond Port Identifier, Port World Wide Name, and Node World Wide Name.

86. The Fibre Channel switch of claim 85 wherein the device entry field comprises a port state field and a device data field.

87. The Fibre Channel switch of claim 86 wherein the device entry field further comprises an indication of a size of the device data field.

88. The Fibre Channel switch of claim 86 wherein the device data field contains one or more fields selected from the group consisting of: Entry Format Indicator, Owner Identifier, Port Type, Port Identifier, Port Name, Port Symbolic Name, Node Name, Node Symbolic Name, Initial Process Associator, Node IP Address, Class of Service, FC-4 Types, Port IP Address, Fabric Port Name, hard Address, FC-4 Features, and FC-4 Descriptor.

89. The Fibre Channel switch of claim 86 wherein the device data field comprises a plurality of parameters about the node device.

90. The Fibre Channel switch of claim 89 wherein the plurality of parameters is determined by selecting one of a plurality of predetermined formats for the device data field, each of the plurality of predetermined formats comprising one or more fields indicative of a status of the node device.

91. A Fibre Channel node device comprising:
a connections configured to communicate with a Fibre Channel switch;
wherein the Fibre Channel node device is configured to receive and interpret a Node Device Registered State Change Notification message sent by the Fibre Channel switch in response to a detected status change in a second Fibre Channel node device; and
wherein the Node Device Registered State Change Notification message comprises additional information beyond Address Format and Affected Port Identifier.

92. The Fibre Channel switch of claim 91 wherein the Node Device Registered State Change Notification message comprises an affected device entry field, the affected device entry field further comprising a port state field and one or more fields selected from the group consisting of Port Identifier, Port World Wide Name, Node World Wide Name, Number of FC-4 Types Supported, and Identification of FC-4 Types Supported.

93. The Fibre Channel switch of claim 91 wherein the device data field comprises a plurality of parameters about the changed node device.
